(19) United States
(12) Patent Application Publication
(10) Pub. No.: US 2026/0136168 A1
(43) Pub. Date: May 14, 2026

(54) A METHOD AND APPARATUS FOR TRANSMITTING AND RECEIVING INFORMATION ELEMENT IN WIRELESS COMMUNICATION SYSTEM

(71) Applicant: Samsung Electronics Co., Ltd., Suwon-si, Gyeonggi-do (KR)

(72) Inventors: Mahmoud WATFA, Staines (GB); Lalith KUMAR, Bangalore (IN)

(21) Appl. No.: 19/120,620

(22) PCT Filed: Oct. 10, 2023
(86) PCT No.: PCT/KR2023/015487

§ 371 Date: Apr. 11, 2025

(30) Foreign Application Priority Data
Oct. 11, 2022 (IN) 202231058072
Nov. 14, 2022 (IN) 202231065138
Sep. 29, 2023 (GB) 2315026.1

(51) Int. Cl. H04W 4/90; H04W 60/04; H04W 76/20

(52) U.S. Cl. CPC H04W 4/90; H04W 60/04; H04W 76/20

(57) ABSTRACT

Disclosed is a method of operating a User Equipment, UE, where the UE is in a non-allowed area, or the UE is not in an allowed area and wherein the UE wishes to request User Plane, UP, resources for a Protocol Data Unit, PDU, in a Non-Access Stratum, NAS, message, the UE includes a specified Information Element, IE, only when the UP resources are for a PDU session for emergency service and wherein the specified IE only indicates a PDU session ID associated with emergency access.

### CROSS-REFERENCE TO RELATED APPLICATION(S)

This application is a U.S. National Stage application under 35 U.S.C. § 371 of an International application number PCT/KR2023/015487, filed on Oct. 10, 2023, which is based on and claims priority of an Indian patent application number 202231058072, filed on Oct. 11, 2022, in the Indian Patent Office, of an Indian patent application number 202231065138, filed on Nov. 14, 2022, in the Indian Patent Office, and of a United Kingdom patent application number 2315026.1, filed on Sep. 29, 2023, in the United Kingdom Patent Office, the disclosure of each of which is incorporated by reference herein in its entirety.

### TECHNICAL FIELD

The present invention relates to addressing possibly contradictory behaviour in a User Equipment in certain circumstances. The circumstances relate, in particular, to certain modes of operation related to when the UE in or outside a non-allowed area.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mm Wave, supporting numerologies (for example, operating multiple subcarrier spacings) for efficiently utilizing mm Wave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE

### Technical Solution

Accordingly, the embodiments herein provide a method of a user equipment, UE, in a wireless communication system. The method comprises determining to request user plane, UP, resources of a protocol data unit, PDU, session in a non-access stratum, NAS, message; in case that the UP resources are for the PDU session of emergency service, including a specified information element, IE, in the NAS message; and transmitting a request for the UP resources of the PDU session in the NAS message, wherein the specified IE indicates a PDU session identifier, ID, associated with emergency access of the emergency service, and wherein the UE is in a non-allowed area or not in an allowed area.

In the embodiments, a method of an access and mobility management function, AMF, in a wireless communication system, is provided. The method comprises determining that a user equipment, UE, is in a restricted service area; and receiving a request for user plane, UP, resources of a protocol data unit, PDU, session in a non-access stratum, NAS, message including at least one specified IE; and in case that the specified IE indicates that the UP resources are for the PDU session of emergency service, accepting the request and establishing the user plane resources for the PDU session on 3GPP access.

In the embodiments, a user equipment, UE, in a wireless communication system is provided. The UE comprises a transceiver; and at least one processor coupled to the transceiver and configured to control the overall operation of the UE in the method of the UE as described above.

In the embodiments, an access and mobility management function, AMF, in a wireless communication system is provided. The AMF comprises a transceiver; and at least one processor coupled to the transceiver and configured to control the overall operation of the AMF in the method of the UE as described above.

### DESCRIPTION OF DRAWINGS

These and other features, aspects, and advantages of the present invention is illustrated in the accompanying drawings, throughout which like reference letters indicate corresponding parts in the various figures. The embodiments herein will be better understood from the following description with reference to the drawings, in which:

FIG. 1 is a flow chart illustrating a method for a user equipment, UE, according to the embodiments as disclosed herein.

FIG. 2 is a flow chart illustrating a method for a user equipment, UE, according to the embodiments as disclosed herein.

FIG. 3 is a block diagram of the UE, according to the embodiments as disclosed herein.

FIG. 4 is a block diagram of an access and mobility function, AMF, according to the embodiments as disclosed herein.

### MODE FOR INVENTION

The following description with reference to the accompanying drawings is provided to assist in a comprehensive understanding of embodiments of the disclosure. It includes various specific details to assist in that understanding but these are to be regarded as merely examples. Accordingly, those of ordinary skill in the art will recognize that various changes and modifications of the embodiments described herein can be made without departing from the scope and spirit of the present disclosure. In addition, descriptions of well-known functions and constructions may be omitted for the sake of clarity and conciseness.

The terms and words used in the following description and claims are not limited to the bibliographical meanings, but are merely used by the inventor to enable a clear and consistent understanding of the present disclosure. Accordingly, it should be apparent to those skilled in the art that the following description of embodiments of the disclosure is provided for illustration purposes only and not for the purpose of limiting the present disclosure.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in embodiments of the disclosure and does not limit one or more additional functions, operations, or components. The terms such as “include” and/or “have” may be construed to denote a certain characteristic, number, step, operation, constituent element, component or a combination thereof, but may not be construed to exclude the existence of or a possibility of addition of one or more other characteristics, numbers, steps, operations, constituent elements, components or combinations thereof.

The term “or” used in embodiments of the disclosure includes any or all of combinations of listed words. For example, the expression “A or B” may include A, may include B, or may include both A and B.

The message names herein are merely examples, and other message names may be used. Terms such as “first” and “second” included in the message names herein are merely examples of the messages, and do not represent the performing order. The steps in individual processes may be performed in combination with each other or independently. The performing steps of each process are merely examples, and other possible performing orders are not excluded.

Herein, the base station may be a 5G base station (such as gNB, ng-eNB), a 4G base station (such as eNB), a sixth generation (6G) base station, or other types of access nodes.

Unless defined differently, all terms used herein, which include technical terminologies or scientific terminologies, have the same meaning as that understood by a person skilled in the art to which the present disclosure pertains. Such terms as those defined in a generally used dictionary are to be interpreted to have the same meanings as the contextual meanings in the relevant field of art and are not to be interpreted to have ideal or excessively formal meanings unless clearly defined in the present disclosure.

The Fifth Generation System, 5GS, defines the concept of service area restriction as either being an allowed area or a non-allowed area. The User Equipment, UE, is expected to obtain normal service if it is in an allowed area, or if it is not in a non-allowed area. In this case the UE will be in state 5GMM-REGISTERED.NORMAL-SERVICE.

The UE cannot get normal service (or may get restricted services) if the UE is in a non-allowed area, or if the UE is not in an allowed area. In this case the UE will be in state 5GMM-REGISTERED.NON-ALLOWED-SERVICE.

The detailed UE behaviour when in a restricted service area (i.e. when the UE is in a non-allowed area or when the UE is not in an allowed area) is defined in 3GPP TS 24.501V 18.0.1. The relevant portion is shown below:
“5.3.5 Service area restrictions
5.3.5.1 General
Service area restrictions are applicable only to 3GPP access and to wireline access.
Subclause 5.3.5.2 applies when the UE accesses 5GCN over 3GPP access.
Subclause 5.3.5.3 applies when the 5G-RG or the W-AGF acting on behalf of an FN-CRG (or on behalf of the N5GC device) access 5GCN over wireline access.
NOTE: Service area restrictions are not applicable for the W-AGF acting on behalf of the FN-BRG.
5.3.5.23GPP access service area restrictions

The service area restrictions consist of tracking areas forming either an allowed area, or a non-allowed area. The tracking areas belong to either the registered PLMN or its equivalent PLMNs in the registration area. The allowed area can contain up to 16 tracking areas or include all tracking areas in the registered PLMN and its equivalent PLMN(s) in the registration area. The non-allowed area can contain up to 16 tracking areas. The network conveys the service area restrictions to the UE by including either an allowed area, or a non-allowed area, but not both, in the Service area list IE of a REGISTRATION ACCEPT message or a CONFIGURATION UPDATE COMMAND message.

If the network does not convey the service area restrictions to the UE in the Service area list IE of a REGISTRATION ACCEPT message, the UE shall treat all tracking areas in the registered PLMN and its equivalent PLMN(s) in the registration area as allowed area and delete the stored list of “allowed tracking areas” or the stored list of “non-allowed tracking areas”.

When the UE receives a Service area list IE with an allowed area indication during a registration procedure or a generic UE configuration update procedure:
a) if the “Type of list” included in the Service area list IE does not indicate “all TAIs belonging to the PLMNs in the registration area are allowed area”, the UE shall delete the old list of “allowed tracking areas” and store the tracking areas in the allowed area as the list of “allowed tracking areas”. If the UE has a stored list of “non-allowed tracking areas”, the UE shall delete that list; or
b) if the “Type of list” included in the Service area list IE indicates “all TAIs belonging to the PLMNs in the registration area are allowed area”, the UE shall treat all tracking areas in the registered PLMN and its equivalent PLMN(s) as allowed area and delete the stored list of “allowed tracking areas” or the stored list of “non-allowed tracking areas”.

When the UE receives a Service area list IE with a non-allowed area indication during a registration procedure or a generic UE configuration update procedure, the UE shall delete the old list of “non-allowed tracking areas” and store the tracking areas in the non-allowed area as the list of “non-allowed tracking areas”. If the UE has a stored list of “allowed tracking areas”, the UE shall delete that list.

If the UE is successfully registered to a PLMN and has a stored list of “allowed tracking areas”:
a) while the current TAI is in the list of “allowed tracking areas”, the UE shall stay in, or enter, the state 5GMM-REGISTERED.NORMAL-SERVICE and is allowed to initiate any 5GMM and 5GSM procedures; and
b) while the UE is camped on a cell which is in the registered PLMN or a PLMN from the list of equivalent PLMNs and the current TAI is not in the list of “allowed tracking areas”, the UE shall enter the state 5GMM-REGISTERED.NON-ALLOWED-SERVICE, and:
   1) if the UE is in 5GMM-IDLE mode or 5GMM-IDLE mode with suspend indication over 3GPP access, the UE:
      i) shall not include the Uplink data status IE in the registration procedure for mobility and periodic registration update except for emergency services or for high priority access;
      ii) shall not perform the registration procedure for mobility and periodic registration update with Follow-on request indicator set to “Follow-on request pending”, except for:
         emergency services;
         high priority access;
         indicating a change of 3GPP PS data off UE status;
         sending an SOR transparent container;
         sending a UE policy container; or
         sending a UE parameters update transparent container;
      iii) shall not initiate a service request procedure or request the lower layers to resume a suspended connection, except for:
         emergency services;
         emergency services fallback;
         high priority access;
         responding to paging;
         responding to notification received over non-3GPP access;
         indicating a change of 3GPP PS data off UE status;
         sending an SOR transparent container;
         sending a UE policy container; or
         sending a UE parameters update transparent container; and
   2) if the UE is in 5GMM-CONNECTED mode or 5GMM-CONNECTED mode with RRC inactive indication over 3GPP access, the UE:
      i) shall not perform the registration procedure for mobility and periodic registration update with Uplink data status IE except for emergency services or for high priority access;
      ii) shall not initiate a service request procedure except for:
         emergency services;
         emergency services fallback;
         high priority access;
         responding to paging or responding to notification received over non-3GPP access;
      iii) shall not initiate a 5GSM procedure except for:
         emergency services;
         high priority access; or
         indicating a change of 3GPP PS data off UE status; and
      iv) shall not perform the NAS transport procedure except for the sending:
         SMS;
         an LPP message;
         a location services message;
         an SOR transparent container;
         a UE policy container;
         a UE parameters update transparent container; or
         a CIoT user data container.

NOTE 1: The contents of CIoT user data container can be data that is not for exception reports, or data that is for exception reports if allowed for the UE (see subclause 6.2.13).

If the UE is successfully registered to a PLMN and has a stored list of “non-allowed tracking areas”:
a) while the UE is camped on a cell which is in the registered PLMN or a PLMN from the list of equivalent PLMNs and the current TAI is not in the list of “non-allowed tracking areas”, the UE shall stay in, or enter, the state 5GMM-REGISTERED.NORMAL-SERVICE and is allowed to initiate any 5GMM and 5GSM procedures; and
b) while the current TAI is in the list of “non-allowed tracking areas”, the UE shall enter the state 5GMM-REGISTERED.NON-ALLOWED-SERVICE, and:
   1) if the UE is in 5GMM-IDLE mode or 5GMM-IDLE mode with suspend indication over 3GPP access, the UE:
      i) shall not include the Uplink data status IE in the registration procedure for mobility and periodic registration update except for emergency services or for high priority access;
      ii) shall not perform the registration procedure for mobility and periodic registration update with Follow-on request indicator set to “Follow-on request pending”, except for:
         emergency services;
         high priority access;
         indicating a change of 3GPP PS data off UE status;
         sending an SOR transparent container;
         sending a UE policy container; or
         sending a UE parameters update transparent container; and
      iii) shall not initiate a service request procedure or request the lower layers to resume a suspended connection, except for:
         emergency services;
         emergency services fallback;
         high priority access;
         responding to paging;
         responding to notification received over non-3GPP access;
         indicating a change of 3GPP PS data off UE status;
         sending an SOR transparent container;
         sending a UE policy container; or
         sending a UE parameters update transparent container; and
   2) if the UE is in 5GMM-CONNECTED mode or 5GMM-CONNECTED mode with RRC inactive indication over 3GPP access, the UE:
      i) shall not perform the registration procedure for mobility and registration update with the Uplink data status IE except for emergency services or for high priority access;
      ii) shall not initiate a service request procedure or request the lower layers to resume a suspended connection, except for:
         emergency services;
         emergency services fallback;
         high priority access; or
         responding to paging or responding to notification received over non-3GPP access;
      iii) shall not initiate a 5GSM procedure except for:
         emergency services;
         high priority access; or
         indicating a change of 3GPP PS data off UE status; and
      iv) shall not perform the NAS transport procedure except for the sending:
         SMS;
         an LPP message;
         a location services message;
         an SOR transparent container;
         a UE policy container;
         a UE parameters update transparent container; or
         a CIoT user data container.

NOTE 2: The contents of CIoT user data container can be data that is not for exception reports, or data that is for exception reports if allowed for the UE (see subclause 6.2.13).

The list of “allowed tracking areas”, as well as the list of “non-allowed tracking areas” shall be erased when:
a) the UE is switched off; and
b) the UICC containing the USIM is removed or an entry of the “list of subscriber data” with the SNPN identity of the SNPN is updated.

When a tracking area is added to the list of “5GS forbidden tracking areas for roaming” or to the list of “5GS forbidden tracking areas for regional provision of service” as specified in the subclauses 5.5.1.2.5 or 5.5.1.3.5, the tracking area shall be removed from the list of “allowed tracking areas” if the tracking area is already present in the list of “allowed tracking areas” and from the list of “non-allowed tracking areas” if the tracking area is already present in the list of “non-allowed tracking areas”.

The text above therefore shows what the UE is allowed to do, or what the UE is not allowed to do when it is in a restricted service area.

It is clear that when the UE is not in an allowed area, then the UE cannot request user plane resources with the service request procedure except:
if the session is for emergency services; or
because the UE is a high access priority UE.

The technical contribution identified as “C1-225904, Condition for inclusion of Uplink data status IE in non-allowed service area, 3GPP TSG-CT WG1 Meeting #138-e, E-Meeting, 10-14 Oct. 2022” makes this more explicit. For example it modifies the section shown above to indicate the following:
“The UE shall not include the Uplink data status IE in the SERVICE REQUEST message or CONTROL PLANE SERVICE REQUEST message except for emergency services or for high priority access”

It should be noted that the UE uses the Uplink data status Information Element, IE, in order to request the establishment of user plane, UP, resources.

The Allowed Protocol Data Unit, PDU, session status IE is used to request the transfer of a PDU session from the non-3GPP access to the 3GPP access. This IE is sent by the UE and can be included in the Service Request message, or the Registration Request message as described in 3GPP TS 24.501V 18.0.1.

For example, the following is described in section 5.6.1.2.1 of 3GPP TS 24.501V 18.0.1.
about the use of this IE:
   “if the paging request includes an indication for non-3GPP access type, the Allowed PDU session status IE shall be included in the SERVICE REQUEST message. If the UE has established the PDU session(s) over the non-3GPP access for which the associated S-NSSAI(s) are included in the allowed NSSAI for 3GPP access, the UE shall indicate the PDU session(s) for which the UE allows the user-plane resources to be re-established over 3GPP access in the Allowed PDU session status IE. Otherwise, the UE shall not indicate any PDU session(s) in the Allowed PDU session status IE”

Therefore, when paged, the UE may request the transfer of session from non-3GPP to 3GPP access by means of the Allowed PDU session status IE.

It should be noted that the transfer of a PDU session can also be done by virtue of explicit 5GSM Non-Access Stratum, NAS, signalling and specifically by sending a PDU Session Establishment Request message. This message can be used by the UE to transfer the session across accesses. This is clearly stated in section 6.4.1.1 of 3GPP TS 24.501V 18.0.1:
“The purpose of the UE-requested PDU session establishment procedure is to establish a new PDU session with a DN, to perform handover of an existing PDU session between 3GPP access and non-3GPP access, to transfer an existing PDN connection in the EPS to the 5GS, to transfer an existing PDN connection in an untrusted non-3GPP access connected to the EPC to the 5GS, or to establish an MA PDU session to support ATSSS (see 3GPP TS 24.193[13 B]), or to relay the service associated with the RSC for 5G ProSe layer-3 UE-to-network relay (see 3GPP TS 24.554 [19E]). If accepted by the network, the PDU session enables exchange of PDUs between the UE and the DN.”

To summarize, it can be seen that a session could be transferred across accesses either by the use of explicit 5GSM NAS messages, or by using the Allowed PDU session status IE (which is only applicable to the case of a session transfer from non-3GPP to 3GPP access).

A problem with the prior art is that the current standards specification, including “C1-225904, Condition for inclusion of Uplink data status IE in non-allowed service area, 3GPP TSG-CT WG 1 Meeting #138-e, E-Meeting, 10-14 Oct. 2022” have not considered the Allowed PDU session status IE.

When a UE is in a restricted service area (i.e. when the UE is not in an allowed area, or when the UE is in a non-allowed area), then the UE is not allowed to send 5GSM messages as already stated. This also means that the UE is not allowed to use 5GSM messages to transfer a session from non-3GPP to 3GPP access, except if the session in question is for emergency.

However, neither 3GPP TS 24.501 V 18.0.1 and “C1-225904, Condition for inclusion of Uplink data status IE in non-allowed service area, 3GPP TSG-CT WG1 Meeting #138-e, E-Meeting, 10-14 Oct. 2022” have considered the use of the Allowed PDU session status IE when the UE is in a restricted service area.

This leads to contradictory UE behaviour and potential ‘bypass’ of the requirements in the sense that while the UE is not allowed to use explicit 5GSM NAS messages to transfer a session from non-3GPP to 3GPP, it can take advantage of being paged to do so. This is because there is currently no restriction on the use of the Allowed PDU session status IE for a UE in a non-allowed area (or for a UE that is not in an allowed area, or for a UE which is outside of an allowed area).

Therefore this problem in the prior art needs to be addressed, as it makes the UE behaviour unclear and inconsistent, which can result in unstable and unpredictable operation of the UE and/or the network.

According to the present invention there is provided an apparatus and method as set forth in the appended claims. Other features of the invention will be apparent from the dependent claims, and the description which follows.

According to a first aspect of the present invention, there is provided a method of operating a User Equipment, UE, where the UE is in a non-allowed area, or the UE is not in an allowed area and wherein the UE wishes to request User Plane, UP, resources for a Protocol Data Unit, PDU, in a Non-Access Stratum, NAS, message, the UE includes a specified Information Element, IE, only when the UP resources are for a PDU session for emergency service and wherein the specified IE only indicates a PDU session ID associated with emergency access.

In an embodiment, the UP resources are associated with 3GPP access.

In an embodiment, the NAS message is one of a Service Request message, a Control Plane Service Request, CPSR, message, or a Registration Request message.

In an embodiment, the specified IE is one of an Allowed Protocol Data Unit, PDU, session status IE and an Uplink data status IE.

In an embodiment, any PDU session IDs not associated with emergency access are set to 0.

In an embodiment, if no PDU session is associated with emergency access, then the specified IE is not transmitted.

According to a second aspect of the present invention, there is provided a method of operating a User Equipment, UE, where the UE is in a non-allowed area, or the UE is not in an allowed area and wherein the UE wishes to request User Plane, UP, resources for a Protocol Data Unit, PDU, in a Non-Access Stratum, NAS, message, the UE includes a specified Information Element, IE, only when the UP resources are associated with the UE having high-priority access.

In an embodiment, the UP resources are associated with 3GPP access.

In an embodiment, the NAS message is one of a Service Request message, a Control Plane Service Request, CPSR, message, or a Registration Request message.

In an embodiment, the specified IE is one of an Allowed Protocol Data Unit, PDU, session status IE and an Uplink data status IE.

In an embodiment, any one or more PDU session ID not associated with high priority access is set to 0.

In an embodiment, if the UE is not associated with high-priority access, then the specified IE is not transmitted

According to a third aspect of the present invention, there is provided method of operating an Access and Mobility management Function, AMF, in a telecommunication network wherein if the AMF determines that a UE, with which it is in communication is in a restricted service area, and if the AMF receives a NAS message with at least one specified IE, then:
if the IE indicates that user plane resources are required for a PDU session which is a session for emergency services, then the AMF accepts the request or processes the IE and optionally establishes user plane resources for the PDU emergency session on 3GPP access; or
if the IE indicates that user plane resources are required for a PDU session which is not an emergency PDU session, then the AMF does not establish the user plane resources; or
if the UE is a high priority access UE or the access is for a high priority access, then the AMF can establish user plane resources for any PDU session; or
the AMF ignores any bit corresponding to a PDU session for which user plane resources are requested and the PDU session in question, identified by the PDU session ID of the bit position, is not a PDU session for emergency services; or
the AMF informs the UE in a NAS response message about each PDU session for which no user plane resources were established.

According to a third aspect of the present invention, there is provided apparatus arranged to perform the method of any preceding aspect.

Throughout the following it is important to properly understand the context on allowed and non-allowed areas.

It should be noted that a UE in a restricted service area can mean that the UE is not in an allowed area, or the UE is outside an allowed area, or the UE is in a non-allowed area. In this case, the UE is in state 5GMM-REGISTERED.NON-ALLOWED-SERVICE.

It should also be noted that a UE which is not in a restricted service area can mean that the UE is in an allowed area, or the UE is outside a non-allowed area, or the UE is not in a non-allowed area. In this case, the UE is in state 5GMM-REGISTERED.NORMAL-SERVICE.

Although a few preferred embodiments of the present invention have been shown and described, it will be appreciated by those skilled in the art that various changes and modifications might be made without departing from the scope of the invention, as defined in the appended claims.

For a better understanding of the invention, and to show how embodiments of the same may be carried into effect, reference will now be made, by way of example only, to the accompanying diagrammatic drawings in which:

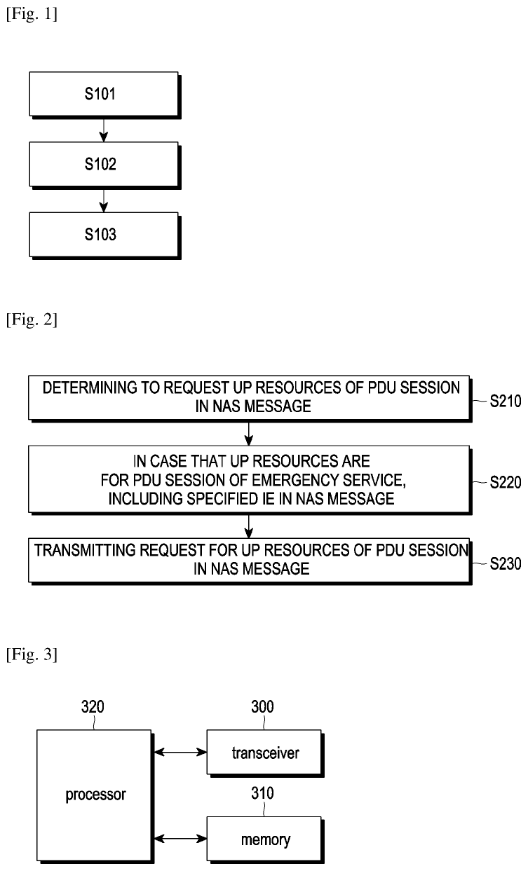

FIG. 1 shows a flowchart illustrating an embodiment of the present invention.

In one embodiment, a modified behaviour with respect to the use of the Allowed PDU session status IE is provided.

When (or if) the UE is in a non-allowed area, or when (or if) the UE is not in an allowed area, then the UE should not include the Allowed PDU session status IE in the Service Request message, or in the Control Plane Service Request, CPSR, message, or in the Registration Request message. Alternatively, the Allowed PDU session status IE may be included, but with all bit positions set to 0.

However, if the UE has a PDU session for emergency services and the UE wants (or wishes or needs) to request the transfer of the PDU session for emergency services (e.g. from the non-3GPP access to the 3GPP access), then the UE can include the Allowed PDU session status IE in the Service Request message, or in the Control Plane Service Request message, or in the Registration Request message. In this case, the Allowed PDU session status IE should indicate that only the PDU session for emergency services is desired to be transferred. In other words, the Allowed PDU session status IE should indicate that user plane resources are requested to be established on the 3GPP access only for the emergency PDU session (i.e. the IE cannot request user plane resource establishment on the 3GPP access for other PDU sessions-except if the UE is also a high priority access UE).

In other words, for a UE which is in a restricted service area, the UE can only include the Allowed PDU session status IE in the NAS message (e.g. Service Request message, or in the Control Plane Service Request message, or in the Registration Request message) to request the establishment of user-plane resources (on the 3GPP access) for an emergency PDU session (which is currently, or which was, associated with the non-3GPP access). As such, the Allowed PDU session status IE can only indicate a PDU session ID for which user-plane resources of the corresponding PDU session can be re-established over 3GPP access if the PDU session ID is associated with a PDU session for emergency services.

Therefore, if a UE does not have any emergency PDU session which is desired to be transferred from non-3GPP access to the 3GPP access (or for which the UE requests that user-plane resources of corresponding PDU session can/should be re-established over 3GPP access), then the UE should not include the Allowed PDU session status IE in the NAS messages which have been listed above.

The details above also apply for a high priority access UE.

As such when a UE is in a restricted service area, if the UE is a high priority access UE, or if the access is for high priority access, then the UE can include the Allowed PDU session status IE in the NAS messages that have been listed above. Otherwise, if the access is not for a high priority access (or if the UE is not a high priority access UE), then the UE should not include the Allowed PDU session status IE in the NAS messages which have been listed.

As such, the following details apply:
The UE shall not include the Allowed PDU session status IE in the SERVICE REQUEST message, or in the CONTROL PLANE SERVICE REQUEST message or in the REGISTRATION REQUEST message, except for emergency services or for high priority access
   For the case of emergency services, the Allowed PDU session status IE can only be used to request the establishment of user plane resources (e.g. over the 3GPP access) of the PDU session which is the emergency PDU session
   For the case of high priority access (or for a UE which is a high priority access), the UE can request the establishment of user plane resources (e.g. over the 3GPP access) for more than one PDU session or optionally for any PDU session

As such, the UE should verify whether it is in a restricted service area or not in order to determine if it can include the Allowed PDU session status IE:
If the UE is not in a restricted service area (i.e. if the UE is in an allowed area, or if the UE is outside a non-allowed area), then the UE can include the Allowed PDU session status IE in the NAS messages listed above (optionally without any restriction)
If the UE is in a restricted service area (i.e. if the UE is in a non-allowed area, or if the UE is outside an allowed area), then the UE can not include the Allowed PDU session status IE in the NAS messages listed above unless:
   If the IE is being used to request the user plane resources for an emergency PDU session (or for a PDU session for emergency services) as described earlier, or
   If the UE is a high priority access UE, or the request is for a high priority access as described earlier.

For any of the situations herein in which an IE is allowed to be included in the NAS message e.g. the Allowed PDU session status IE or the Uplink data status IE, the UE when including the IE should only request user plane resources—namely, by setting the appropriate PDU session ID bit such that user plane is requested (to the value 1) or by including an indication such that user plane is requested—for those PDU sessions for which an exception is allowed such that user plane can be requested and/or established.

For example, when sending the Allowed PDU session status IE due to the presence of an emergency PDU session (as set out earlier), the UE should set the PDU session ID, corresponding to the emergency PDU session, to a value which indicates that user plane is requested, however all other PDU sessions should have their corresponding bits set to a value indicating that user plane is not requested.

Therefore, the operation of this embodiment can be summarized as follows: when sending any IE due an exception as set out herein, the UE should not request user plane resources for all the PDU sessions just because the IE is allowed to be sent. The UE should only set the bit positions of the IE to correspond to those PDU sessions for which exceptions are made such that user plane resources are requested, e.g. for the emergency PDU session, while all other PDU sessions should not indicate that user plane resources are required.

As such, the exception to include an IE should not permit a request for user plane resources for all PDU sessions but rather for the specific PDU sessions for which exceptions are made.

In the case of a high priority access UE, since the UE is a high priority access, then in addition to the UE being allowed to include the IE (e.g. Allowed PDU session status IE or Uplink data status IE), the UE can request the user plane resource establishment for any PDU session, since a high priority access UE is not restricted to the use of a particular PDU session such as the emergency PDU session.

Note that the details herein apply to both the Uplink data status IE and the Allowed PDU session status IE. As such, all the details provided in relation to the Allowed PDU session status IE also apply for the Uplink data status IE.

Note that the options/steps set out above can apply in any order or combination.

Optionally, if the UE receives a NOTIFICATION message on the non-3GPP access, and the access type indicates 3GPP access, then the UE should behave as follows:
When responding to the NOTIFICATION with a NAS message, such as the Service Request, Control Plane Service Request, or Registration Request, the UE behaves in the same manner as described above. As such, the detailed operation above would apply here for this case as well.
Note that the options/steps set out can apply in any order or combination.

In another embodiment, modified Access and Mobility management Function, AMF, behaviour is provided with respect to the use of the Allowed PDU session status IE.

If the AMF determines that a UE is in a restricted service area, and if the AMF receives a Service Request message (or Control Plane Service Request message, or a Registration Request message) with an Allowed PDU session status IE, then the AMF behaves as follows:
If the IE indicates that user plane resources is required (to be established) for a PDU session which is a session for emergency services, then the AMF can accept the request or process the IE (and optionally establish user plane resources for the PDU emergency session on the 3GPP access)
If the IE indicates that user plane resources is required for a PDU session which is not an emergency PDU session, then the AMF does not establish the user plane resources. Optionally the AMF ignores the entire IE if the UE does not have a PDU session for emergency services (e.g. on the non-3GPP access)
The AMF can establish user plane resources for any PDU session if the UE in question is a high priority access UE or the access is for a high priority access
The AMF should ignore any bit (corresponding to a PDU session) for which user plane is requested and the PDU session in question (identified by the PDU session ID of the bit position) is not a PDU session for emergency services
The AMF should inform the UE in the NAS response message (e.g. Service Accept or Registration Accept) about each PDU session for which no user plane resources was established. The AMF can use the PDU session reactivation result IE and/or the PDU session reactivation result error IE to do so. However, this does not apply to an emergency PDU session, or this does not apply for a UE that is high priority access UE (or the access is high priority access).

In another embodiment, if the AMF determines that the UE is in a restricted service area, e.g. the AMF determines that the UE is in a non-allowed area, then the AMF shall not page the UE such that the access type indicates non-3GPP access type.

In another embodiment, if the AMF determines that the UE is in restricted service area, e.g. the AMF determines that the UE is in a non-allowed area, then the AMF shall only send a paging message to the UE if the access type indicates 3GPP access type. Otherwise, if the access type is for non-3GPP access, then the AMF should suppress or abort the paging procedure.

Note that all the details set out above apply equally to the Uplink data status IE as well.

All steps/options can be used in any combination or order.

For completeness, FIG. 1 shows a flowchart, illustrating an embodiment of the invention. At Step S101, the UE is in a non-allowed area or not in an allowed area. At S102, the UE wishes to transfer from non-3GPP access to 3GPP access. At S103, the UE sends a NAS messages (a Service Request or CPSR message), including a specified IE, the IE including only a PDU session ID for a PDU session corresponding to an emergency or high priority access PDU session. All other PDU session IDs should be set to 0.

FIG. 2 is a flow chart illustrating a method for a user equipment, UE, according to the embodiments as disclosed herein.

At step S210, the UE determines to request user plane, UP, resources of a protocol data unit, PDU, session in a non-access stratum, NAS, message. At step S220, in case that the UP resources are for the PDU session of emergency service, the UE includes a specified information element, IE, in the NAS message. At step S230, the UE transmits a request for the UP resources of the PDU session in the NAS message. In an embodiment, the specified IE indicates a PDU session identifier, ID, associated with emergency access of the emergency service, and the UE is in a non-allowed area or not in an allowed area.

In an embodiment, wherein the UP resources are associated with 3GPP access. In an embodiment, the NAS message comprises at least one of a service request message, a control plane service request, CPSR, message, or a registration request message. In an embodiment, the specified IE is one of an allowed protocol data unit, PDU, session status IE and an uplink data status IE. In an embodiment, a PDU session identifier, ID not associated with the emergency access is set to 0. In an embodiment, in case that no PDU session is associated with the emergency access, the specified IE is not transmitted.

In an embodiment, the specified IE is included in the NAS message, in case that the UP resources are associated with the UE having high-priority access. In an embodiment, the UP resources are associated with 3GPP access. In an embodiment, the specified IE is one of an allowed PDU session status IE and an uplink data status IE. In an embodiment, at least one PDU session ID not associated with high priority access is set to 0. In an embodiment, in case that the UE is not associated with high-priority access, the specified IE is not transmitted

FIG. 3 is a block diagram of the UE, according to the embodiments as disclosed herein.

The UE according to an embodiment of the present disclosure may include a processor 320 that controls the overall operation of the UE in the method as described above, a transceiver 300 including a transmitter and a receiver, and a memory 310. The present invention is not limited to the above example, and the UE may include more or fewer configurations than the configuration shown in FIG. 3.

According to an embodiment of the present disclosure, the transceiver 300 may transmit and receive signals to and from network entities or other UEs. The signals transmitted and received with the UE may include control information and data. In addition, the transmission/reception unit 300 can receive a signal through a wireless channel and output it to the processor 320 and transmit the signal output from the processor 320 through a wireless channel.

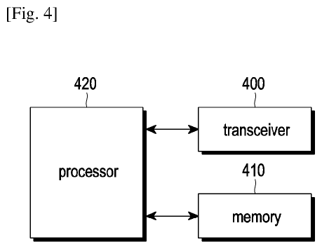

FIG. 4 is a block diagram of an access and mobility function, AMF, according to the embodiments as disclosed herein.

The AMF according to an embodiment of the present disclosure may include a processor 420 that controls the overall operation of the AMF in the method as described above, a transceiver 400 including a transmitter and a receiver, and a memory 410. The present invention is not limited to the above example, and the AMF may include more or fewer configurations than the configuration shown in FIG. 4.

According to an embodiment of the present disclosure, the transceiver 400 may transmit and receive signals to and from network entities or UEs. In addition, the transmission/reception unit (400) can receive a signal through a wireless channel and output it to the processor (420), and transmit the signal output from the processor (420) through a wireless channel.

In an embodiment, the processor (420) is configured to determine that a user equipment, UE, is in a restricted service area, receive a request for user plane, UP, resources of a protocol data unit, PDU, session in a non-access stratum, NAS, message with at least one specified IE, and
in case that the specified IE indicates that the UP resources are for the PDU session of emergency service, accept the request and establish the user plane resources for the PDU session on 3GPP access.

In an embodiment, the processor (420) is configured to establish the user plane resources for the PDU session, in case that the UE is a high priority access UE or the access is for a high priority access, in case that the PDU session is not for the emergency service, ignore a bit corresponding to the PDU session, or inform the UE in the NAS response message about each PDU session for which no user plane resources were established.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1-15. (canceled)

16. A method of a user equipment (UE) in a wireless communication system, the method comprising:
determining to request user plane (UP) resources of a protocol data unit (PDU) session in a non-access stratum, NAS, message; and
in case that the PDU session is for emergency service, including an information element (IE) in the NAS message, and transmitting a request for the UP resources of the PDU session in the NAS message,
wherein the IE indicates that the UP resources of the PDU session for the emergency service are requested, and
wherein the UE is in a non-allowed area or not in an allowed area.

17. The method of claim 16,
wherein the IE indicates a PDU session identifier (ID) associated with the PDU session for the emergency service, and
wherein the UP resources are associated with 3rd generation partnership project (3GPP) access.

18. The method of claim 16, wherein the NAS message includes at least one of a service request message, a control plane service request (CPSR) message, or a registration request message.

19. The method of claim 16, wherein the IE is one of an allowed PDU session status IE and an uplink data status IE.

20. The method of claim 16, wherein a PDU session ID not associated with the emergency service is set to 0.

21. The method of claim 16, wherein in case that no PDU session is associated with the emergency service, the IE is not included in the NAS message.

22. The method of claim 16, wherein the IE is included in the NAS message, in case that the UP resources are associated with the UE having high-priority access.

23. The method of claim 22, wherein the UP resources are associated with 3GPP access.

24. The method of claim 22, wherein the IE is one of an allowed PDU session status IE and an uplink data status IE.

25. The method of claim 22, wherein at least one PDU session ID not associated with high priority access is set to 0.

26. The method of claim 22, wherein in case that the UE is not associated with high-priority access, the IE is not transmitted.

27. A method of an access and mobility management function (AMF) in a wireless communication system, the method comprising:
determining that a user equipment (UE) is in a non-allowed area or not in an allowed area; and
receiving, from the UE, a request for user plane (UP) resources of a protocol data unit, PDU, session in a non-access stratum (NAS) message including an information element (IE); and
in case that the IE indicates that the UP resources of the PDU session for emergency service are requested, accepting the request and establishing the UP resources for the PDU session.

28. The method of claim 27, further comprising:
in case that the UE is a high priority access UE or access related to the UP resources is for a high priority access, establishing the UP resources for the PDU session; or
in case that the PDU session is not for the emergency service, ignoring the request corresponding to the PDU session; or
informing the UE in an NAS response message that each PDU session for which no user plane resources were established.

29. The method of claim 27,
wherein the IE indicates a PDU session identifier (ID) associated with the PDU session for the emergency service, and
wherein the UP resources are associated with 3rd generation partnership project (3GPP) access.

30. The method of claim 27, wherein the NAS message includes at least one of a service request message, a control plane service request (CPSR) message, or a registration request message.

31. The method of claim 27, wherein the IE is one of an allowed PDU session status IE and an uplink data status IE.

32. A user equipment (UE) in a wireless communication system, the UE comprising:
a transceiver; and
at least one processor coupled to the transceiver and configured to:
determine to request user plane (UP) resources of a protocol data unit (PDU) session in a non-access stratum, NAS, message, and
in case that the PDU session is for emergency service, include an information element (IE) in the NAS message, and transmit a request for the UP resources of the PDU session in the NAS message,
wherein the IE indicates that the UP resources of the PDU session for the emergency service are requested, and
wherein the UE is in a non-allowed area or not in an allowed area.

33. The UE of claim 32,
wherein the IE indicates a PDU session identifier (ID) associated with the PDU session for the emergency service, and
wherein the UP resources are associated with 3rd generation partnership project (3GPP) access.

34. An access and mobility management function (AMF) entity in a wireless communication system, the AMF entity comprising:
a transceiver; and
at least one processor coupled to the transceiver and configured to:
determine that a user equipment (UE) is in a non-allowed area or not in an allowed area; and
receive, from the UE, a request for user plane (UP) resources of a protocol data unit, PDU, session in a non-access stratum (NAS) message including an information element (IE); and
in case that the IE indicates that the UP resources of the PDU session for emergency service are requested, accept the request and establishing the UP resources for the PDU session.

35. The AMF entity of claim 34,
wherein the IE indicates a PDU session identifier (ID) associated with the PDU session for the emergency service, and
wherein the UP resources are associated with 3rd generation partnership project (3GPP) access.
